(19) United States
(12) Patent Application Publication
(10) Pub. No.: US 2010/0131959 A1
(43) Pub. Date: May 27, 2010

(54) Proactive application workload management

(76) Inventors: Adam Z. Spiers, London (GB); Till Franke, Friedrichsdorf (DE); Joachim F.M. De Baer, Sinti-gillis-Waas (BE)

Correspondence Address: KING & SCHICKLI, PLLC, 247 NORTH BROADWAY, LEXINGTON, KY, 40507, US

(21) Appl. No.: 12/313,989

(22) Filed: Nov. 26, 2008

(51) Int. Cl. G06F 9/50

(52) U.S. Cl. 718/105

(57) ABSTRACT

A method is provided for continuous optimization of allocation of computing resources for a horizontally scalable application which has a cyclical load pattern wherein each cycle may be subdivided into a number of time slots. A computing resource allocation application pre-allocates computing resources at the beginning of a time slot based on a predicted computing resource consumption during that slot. During the servicing of the workload, a measuring application measures actual consumption of computing resources. On completion of servicing, the measuring application updates the predicted computing resource consumption profile, allowing optimal allocation of resources. Un-needed computing resources may be released, or may be marked as releasable, for use upon request by other applications, including applications having the same or lower priority than the original application. Methods, computer systems, and computer programs available as a download or on a computer-readable medium for installation according to the invention are provided.

### FIELD OF THE INVENTION

Generally, the present invention relates to computing methods and systems for proactively allocating computing resources for use by one or more computing applications, and for optimizing such resource allocation based on predicted and actual computing resource consumption. Particularly, it relates to computing methods and systems, and software incorporating the methods and systems, for pro-actively allocating computing resources to one or more applications requiring such resources based on predicted resource consumption for completion of a computing task by the applications, and for refining the predicted resource consumption using actual measured resource consumption by the applications. The described methods and systems are suited for allocating computing resources to horizontally scalable applications which have cyclic load patterns.

### BACKGROUND OF THE INVENTION

It is common for particular computing applications to encounter workload patterns that increase or decrease over discrete time periods. These workload patterns further may be cyclical, that is, may increase or decrease over time in a pattern wherein the increases or decreases in workload predictably repeat in recurring time slots. Stated differently, at certain hours during the day, at certain days during the week, at certain weeks during the year, or at any recurring time slot in a cyclical time pattern, an application may encounter workload patterns that are significantly greater or less than the hypothetical mean workload for the application when measured across the selected time period. As a non-limiting example, a business may experience a significant increase in orders for products or services at predictable times, such as immediately prior to holidays wherein the exchange of gifts is traditional. In such situations, computing resources must be allocated to address the workload pattern encountered by the application.

Traditionally, reactive methods have been used to address this issue of allocation of computing resources. For example, at the time a particular increase in workload, a request for resources may be issued by the application which is to perform the task, and a number of servers are then tasked or assigned to that application. Such reactive allocation or provisioning is acceptable for non-mission critical applications, such as offline batch processing. However, reactive allocation is unsuitable for mission-critical applications wherein provisioning of insufficient resources could lead to request drops and, the like which would severely impact a business.

It is known also to pro-actively allocate computing resources, that is, to make computing resources available for servicing a particular incoming workload prior to such time as the resources are actually needed. Still further, it is known to pro-actively allocate computing resources based on historical consumption of such resources by a particular application. In that way, no lag is encountered between encountering a need for resources, issuing a request for resources, and actual provisioning of resources to a particular application.

However, even in the situation where computing resources are pro-actively assigned, limitations are encountered. A “worst case” pre-allocation strategy is known, that is, sufficient computing resources are pre-allocated based on usage encountered during the highest load period. However, this strategy is highly wasteful in that accurate predictions of peak usage are difficult and no long-term capacity planning processes are implemented. The worst case pre-allocation strategy results in significant amounts of unused resources during non-peak periods, and is a highly inefficient usage of computing resources.

Similarly, it is known to apply a so-called “one-shot” pre-allocation strategy. In that scenario, based on historical computing resource usage, a set “safety net” of excess resources are allocated to each day. Instant cost savings and improved efficiency in resource utilization are realized, since the total amount of computing resources allocated to each day is less (except for peak usage periods) than in the worst case scenario described above. However, such pre-provisioning strategies can quickly become inaccurate, since workload patterns can quickly change over time. Further, overly cautious “safety net” computing resource allocations must be provided in order to protect against unanticipated spikes in resource usage during a particular period. Thus, if no such spike is encountered, there is still resource waste. If the “safety net” of resources is inadequate for a spike in usage, resource starvation is still encountered.

To prevent such over-provisioning or starvation of computing resources, there is a need in the art for improved methods and systems for pro-actively allocating computing resources. Such methods and systems should contemplate pre-allocation of computing resources based on historical and cyclical patterns of resource consumption, but should also provide continuous optimization to ensure maximum efficiency in resource allocation. Still further, the methods and systems should contemplate release of computing resources deemed un-necessary to service a particular incoming workload.

Virtualization is widely used in data centers, and more and more tasks are accomplished by virtualized entities (virtual machines). Due to the relative simplicity of provisioning/de-provisioning virtual machines, it is desirable to more efficiently match such virtual machines to the constantly changing requirements of the applications consuming them. Thus, desirably the methods and systems will be configured to employ virtual machines for providing computing resources, due to the relative simplicity in tasking such virtual machines to particular applications. Any improvements along such lines should further contemplate good engineering practices, such as relative inexpensiveness, stability, ease of implementation, low complexity, security, unobtrusiveness, etc.

### SUMMARY OF THE INVENTION

The above-mentioned and other problems become solved by applying the principles and teachings associated with the hereinafter-described methods and systems for continuous optimization of allocation of computing resources to a computing application, based on both predicted and actual computing resource consumption by the application. The invention is suited for optimization of resource allocation to applications tasked with addressing incoming workloads, in particular workloads which are cyclical by nature. In one embodiment, computing resources allocated to the application which are found to be unnecessary may simply be released. Alternatively, computing resources allocated to the application which are found to be unnecessary may be marked as releasable or pre-emptible, and may be diverted to other computing applications upon request by the other applications.

Broadly, the invention provides, in a computing system environment, a method for allocating computing resources. Prior to a requirement by a computing application for computing resources to service a workload, at least a portion of resources from a pool of computing resources are allocated to the application according to a resource usage profile for the application according to a workload encountered at a particular time slot. Actual use of computing resources is measured, and the resource usage profile is updated accordingly.

In one aspect, in a computing system environment, a method for continuous optimization of allocation of computing resources includes the step of providing a plurality of servers hosting a pool of computing resources. The computing resources may be defined by virtual machines. Still further, a database comprising a predicted computing resource consumption profile for an application for servicing an incoming workload at one or more time slots is included. The workload may have a pattern which is cyclical in nature over a predetermined time period. A computing resource allocation application, prior to a predetermined time corresponding to the workload for a particular time slot, pre-allocates computing resources according to the predicted computing resource consumption profile for the workload. During completion of the task, a measuring application measures actual consumption of computing resources required to service the workload. Once the time slot has ended, the measuring application updates the predicted computing resource consumption profile database according to the measured actual consumption of computing resources by the application during servicing of the workload during that time slot.

The computing resource allocation application may make pre-allocated computing resources not required for completion of the recurring computing task available for use by other applications. In one embodiment, such un-needed computing resources may simply be released, thereby being made available to other applications. Alternatively, the resources (virtual machines) may simply be discontinued or powered down. In another embodiment, particular computing resources may be marked as releasable or pre-emptible. Accordingly, upon request by another requiring servicing and deemed more urgent or critical than the particular workload to which the computing resources are linked, the marked resources may be diverted for use by the more urgent workload.

In another aspect, a computing system is provided for continuously optimizing the allocation of computing resources. The system includes a plurality of servers hosting a pool of computing resources defined by virtual machines and a database comprising a predicted computing resource consumption profile for a horizontally scalable application which services incoming workloads for which the load pattern is cyclical in nature. Stated differently, the database comprises a predicted computing resource consumption profile for an application which services, over a time period which may be divided into discrete time slots, workloads which tend to increase or decrease substantially predictably at particular time slots, such as certain hours of the day, certain days of the week, certain weeks of the year, and the like.

Also included is a computing resource allocation application and a measuring application as described above. In use, the computing resource allocation application, prior to initiation of a time slot (in the cyclical load pattern of the application) pre-allocates computing resources according to the predicted computing resource consumption profile for the workload for that time slot. The measuring application updates the predicted computing resource consumption profile database for the workload at that time slot according to the measured actual consumption of computing resources by the application during the servicing of the workload. Computing resources deemed unneeded to service the workload may be made available to other applications as described above.

In still yet another aspect, computer program products, available as a download or on a computer-readable medium for installation with a computing device of a user, are provided for accomplishing the described methods. The computer program product may include at least a database component for storing a predicted computing resource consumption profile for a computing application configured for servicing a workload at one or more time slots, a computing resource allocation component which is configured to allocate computing resources, defined by virtual machines, from a pool of computing resources, and a measuring application component which is configured to measure actual consumption of computing resources during the servicing of the workload. The measuring application component is configured to update the predicted computing resource consumption profile database component according to the measured actual consumption of computing resources by the application during the servicing of the workload. Computing resources deemed unnecessary for completion of the recurring computing task may be made available to other applications as described above.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 schematically shows a computing system environment for optimizing computing resource allocation in accordance with the present invention;

FIG. 2 is a flow chart depicting allocation of computing resources for servicing a workload in accordance with the present invention;

FIG. 3 is the flow chart shown in FIG. 2, modified to depict a step of releasing computing resources deemed un-necessary for servicing the workload;

FIG. 4 is the flow chart shown in FIG. 3, modified to depict a step of releasing computing resources deemed un-necessary for servicing the workload and marked as releasable to or pre-emptible by other computing applications which service incoming workloads;

FIG. 5 shows a representative usage of computing resources over a predetermined time frame, in the depicted embodiment being usage of resources over a one week period by a cluster of automated bank teller machines; and

FIG. 6 depicts a representative embodiment of the invention as shown in flow chart form in FIG. 4.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and systems for continuous optimization of computing resource allocation are hereinafter described.

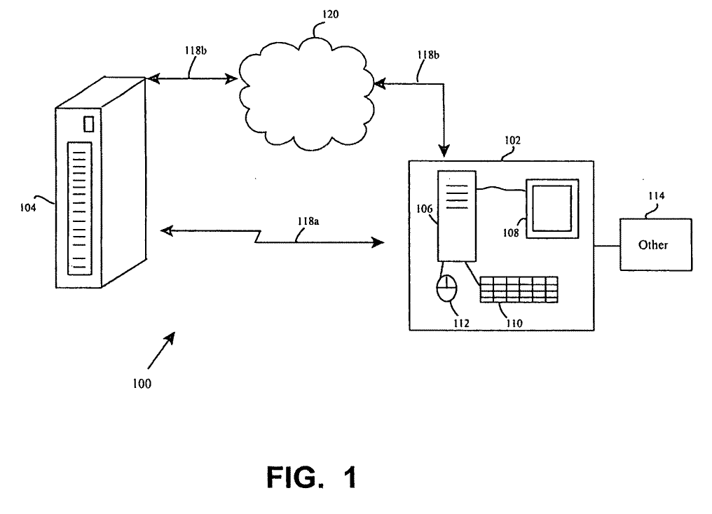

With reference to FIG. 1, a representative computing environment 100 includes a computing device 102 arranged as an individual or networked physical or virtual machine for senders and/or recipients of item(s), including a host 104 and clients arranged with a variety of other networks and computing devices. In a traditional sense, an exemplary host 104 typifies a server, such as a grid or blade server. Brand examples include, but are not limited to, a Windows brand Server, a SUSE Linux Enterprise Server, a Red Hat Advanced Server, a Solaris server or an AIX server. A computing device 102 may also include a server 106, such as a grid or blade server.

Alternatively, a computing device 102 includes a general or special purpose computing device in the form of a conventional fixed or mobile (e.g., laptop) computer 106 having an attendant monitor 108 and user interface, such as a keyboard 110 or a mouse 112. The computer internally includes a processing unit for a resident operating system, such as DOS, WINDOWS, MACINTOSH, LEOPARD, VISTA, UNIX, and LINUX, to name a few, a memory, and a bus that couples various internal and external units, e.g., “Other” 114, to one another. Representative “other” items 114 include without limitation PDA's, cameras, scanners, printers, microphones, joy sticks, game pads, satellite dishes, hand-held devices, consumer electronics, minicomputers, computer clusters, main frame computers, a message queue, a peer computing device, a broadcast antenna, a web server, an AJAX client, a grid-computing node, a virtual machine, a web service endpoint, a cellular phone, or the like. The other items may also be stand alone computing devices in the environment 100 or the computing device 102 itself.

Storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer program products on readable media, e.g., disk for insertion in a drive of computer 106.

It will therefore be appreciated that the system 100 shown in FIG. 1 is configured to perform the tasks required of the present computer system/computing system environment as summarized above, and that computer program products providing computer executable instructions (software) for performing those tasks is contemplated. Computer executable instructions may be made available for installation as a download or may reside in hardware, firmware or combinations in the device 102. When described in the context of computer program products, it is denoted that items thereof, such as modules, routines, programs, objects, components, data structures, etc., perform particular tasks or implement particular abstract data types within various structures of the computing system which cause a certain function or group of functions.

In form, the computer product can be a download of executable instructions resident with a downstream computing device, or readable media, received from an upstream computing device or readable media, a download of executable instructions resident on an upstream computing device, or readable media, awaiting transfer to a downstream computing device or readable media, or any available media, such as RAM, ROM, EEPROM, CD-ROM, DVD, or other optical disk storage devices, magnetic disk storage devices, floppy disks, or any other physical medium which can be used to store the items thereof and which can be assessed in the environment.

In a network, the host 104 and computing device 102 communicate with one another via wired, wireless or combined connections 118 that are either direct 118a or indirect 118b. If direct, they typify connections within physical or network proximity (e.g., intranet). If indirect, they typify connections such as those found with the internet, satellites, radio transmissions, or the like, and are represented schematically as element 120. In this regard, other contemplated items include servers, routers, peer devices, modems, T# lines, satellites, microwave relays or the like. The connections may also be LAN, metro area networks (MAN), and/or wide area networks (WAN) that are presented by way of example and not limitation. The topology is also any of a variety, such as ring, star, bridged, cascaded, meshed, or other known or hereinafter invented arrangement.

Still further, in computer systems and computer system environments, it is known to provide virtual machines. Such virtual machines are known to the skilled artisan to be software implementations of computing devices which are capable of executing applications in the same fashion as a physical computing device. As examples, system virtual machines provide complete system platforms supporting execution of complete operating systems. Process virtual machines are intended to perform a single application or program, i.e., support a single process. In essence, virtual machines emulate the underlying hardware or software in a virtual environment. Many process, system, and operating system-level virtual machines are known to the skilled artisan.

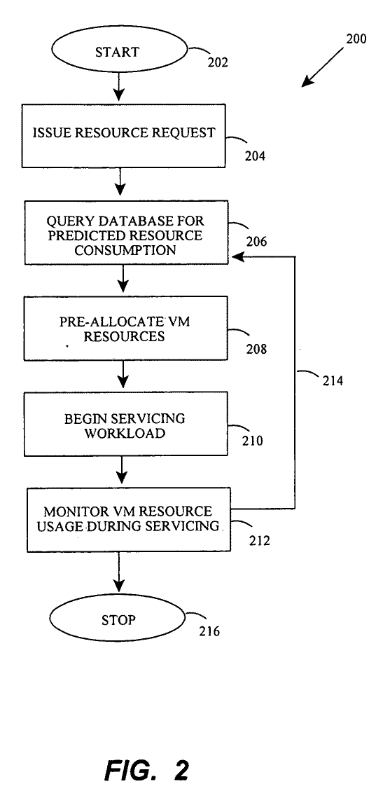

With the foregoing in mind, a representative embodiment of the present invention will now be discussed. With reference to FIG. 2, the overall flow of a process for continuous optimization of allocation of computing resources as described herein is given generically as 200. At start 202 (the beginning of a particular instance of a recurring time slot), a resource request is issued (step 204) in advance of an expected incoming workload for a particular time slot. Typically, the load pattern of the workload will be one which is cyclical in nature, that is, wherein certain levels of load recur at particular time slots, such as certain hours during the day, certain days during the week, certain weeks during the year, etc. At step 206, a predicted resource consumption is determined, based on historical resource consumption required to accomplish the task. That historical resource consumption profile may be contained in a dedicated database which can be queried. Next (step 208), based on that predicted resource consumption, sufficient virtual machine resources are created and pre-allocated to service the incoming workload by a computing resource allocation application, and the servicing step is begun (step 210).

During the servicing of the workload, a measuring application tracks actual resource consumption (step 212). After the workload is serviced, at step 214 the measuring application updates the predicted resource consumption database according to the actual measured resource consumption. In this way, continuous optimization of the allocation of computing resources is achievable.

Of course, while resource consumption by particular applications for servicing workloads with loads that have a cyclical pattern can be extrapolated based on past performance, it is not fully predictable. That is, a workload may require a particular amount of computing resources in a first time slot, but may require additional or fewer resources to accomplish the task in a subsequent corresponding time slot in a subsequent cycle. Using the example of an Internet store ordering engine, more or fewer orders may be placed in a current time period than in a previous corresponding time period. In a market trading example, more or fewer stocks may be bought or sold on a Monday than in the previous Monday. Thus, desirably, un-needed computing resources pre-allocated to a particular application should be made available to other applications.

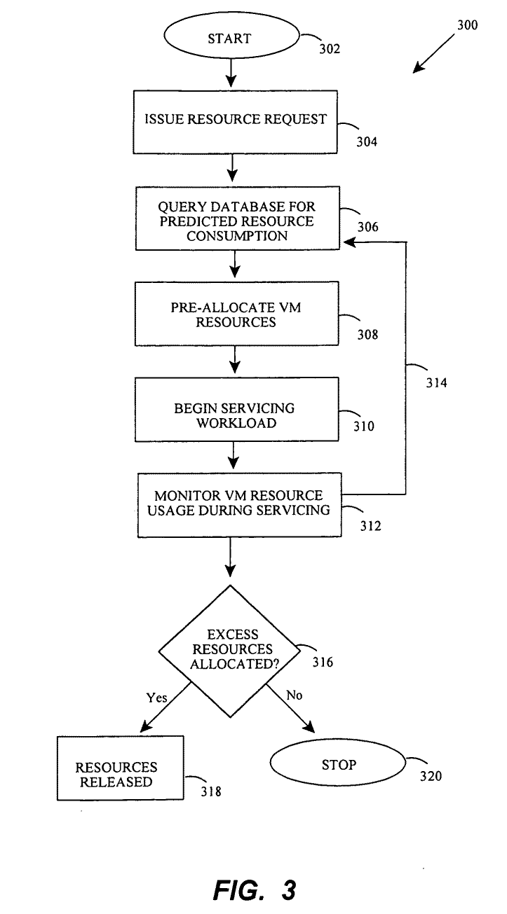

In one embodiment, depicted in FIG. 3, this is accomplished by simply releasing the un-needed computing resources. As a part of the monitoring of virtual machine resource usage during the servicing of the workload (step 312), a determination is made based on the actual resource consumption whether excess computing resources have been allocated. If so, those resources may simply be released (step 318) and made available to other applications. Alternatively (embodiment not shown), the resources may simply be discontinued or powered down.

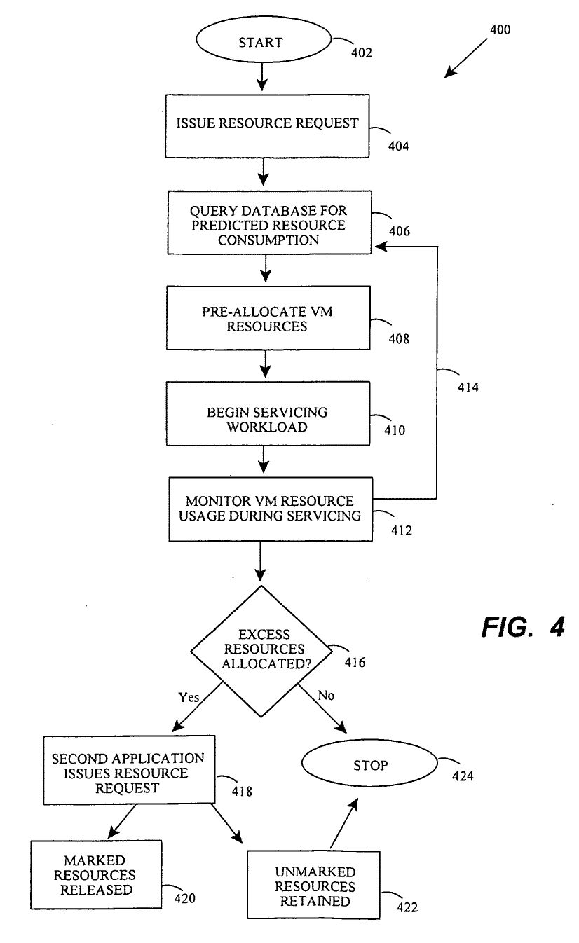

In another embodiment, depicted in FIG. 4, particular resources may be marked or tagged as releasable or preemptible by other applications. For example, of a total of five virtual machine resources deemed necessary based on predictions done for the corresponding time slot (in the cycle) immediately preceding the current time slot, only three of those resources may actually be needed to service the workload based on predictions for the current time slot. On the other hand, it could be desirable to allocate additional resources, despite predictions of resource requirements, to cope with unanticipated spikes in workload during the time slot.

The superfluous resources may be marked or tagged as releasable or preemptible. At step 416, a determination is made based on the actual resource consumption whether excess computing resources have been allocated. A second application which requires computing resources may issue a request for such resources (step 418). The marked resources are then released to the second application. The skilled artisan will appreciate that this feature of cooperative preemption allows not only computing resource optimization, but resource “stealing” without the necessity of forced preemption by an application considered more urgent. That is, even applications considered less urgent are able to divert preemptible computing resources from the currently running application if necessary. Advantageously, this allows sharing of resources between applications, without a requirement for forced preemption of resources by more urgent or critical applications.

The skilled artisan will readily appreciate the applicability of the invention to various cyclical computing workloads, that is, workloads with load patterns that recur in a cyclical fashion and which occupy CPUs for a period of time. As non-limiting examples, market trading activity occurs on a daily pattern (the “daily smile curve”). Automated teller machine activity recurs predictably, in that cash withdrawals peak at predictable times (Friday and Saturday). For payroll applications, typically activity peaks at predictable intervals, such as on a particular day recurring weekly, bi-weekly, or monthly according to the particular payday for a company. Online Internet retail stores and online holiday travel booking businesses experience peak activity at predictable intervals, such as in the week(s) preceding a holiday such as Christmas. In each of these cases, optimal pre-allocation of the necessary computing resources is essential to the efficient operation of the particular business during that time.

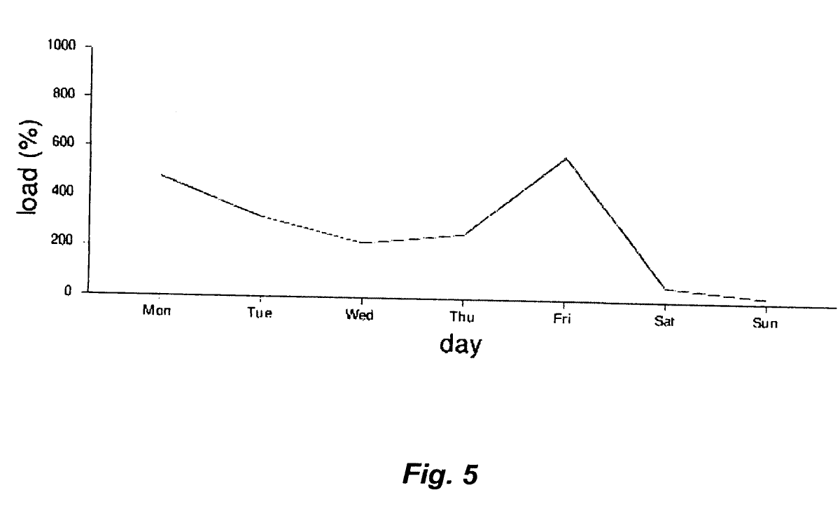

Even lacking a knowledge of the particular business, it is then possible to determine the frequency of the temporal cycle, and to determine when peak computing resources are needed. For example, FIG. 5 presents a hypothetical breakdown of computing resource usage (load expressed as a percent) for a particular computing resource user in a week, in the depicted example being a set or cluster of automated bank teller machines. Peak usage is encountered on Friday, that is, a spike in cash withdrawals is seen as customers prepare for their weekend activities. Of course, the skilled artisan will understand that the particular time period contemplated for the invention is not restricted to the day example of FIG. 5. In the context of an Internet retailer, the time period may be set for a monthly cycle (that is, peak usage in December for Christmas orders), and the like.

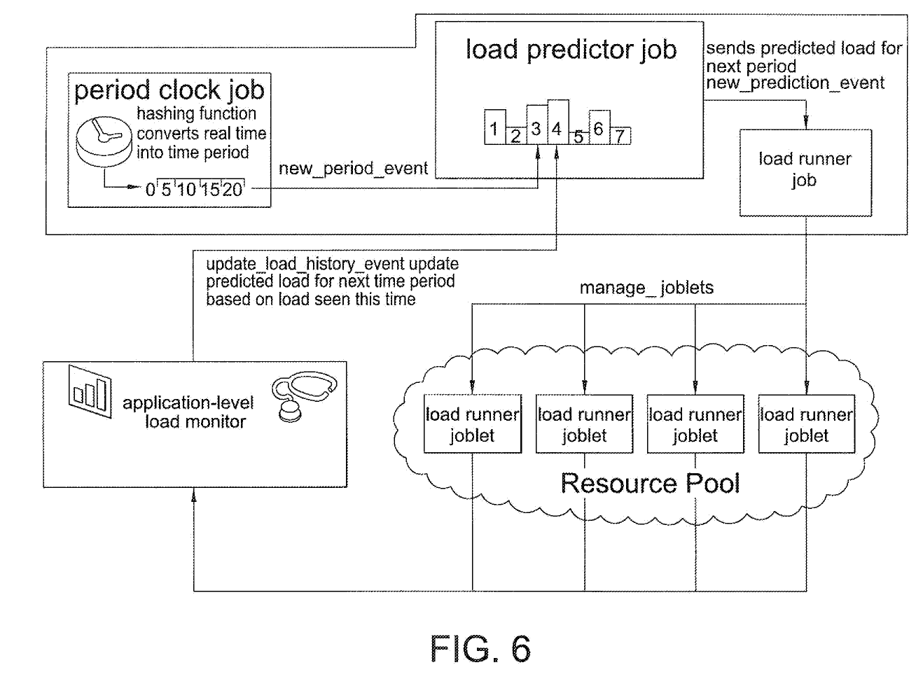

A representative architecture for the present invention is set forth in FIG. 6. A server such as the NOVELL® ZENWORKS® Orchestrator Server publishes a “tick” event at the beginning of a time slot (a day in the example depicted in FIGS. 5 and 6) for any application which may require computing resources on that day. That is, the function shown as period clock job includes a hashing function which converts real time into a discrete time slot, and issues the “tick” event (new_period_event). Next, based on the historical resource consumption profile for a particular workload, the function represented as load predictor job makes a prediction as to the amount of computing resources required for the upcoming time slot (day). The resource consumption profile is maintained in a database. A computing resource allocation application (loadrunner_job) receives the prediction (new_prediction_event) and ensures that the correct number of computing resources are pre-provisioned or pre-allocated to the workload (manage_joblets) from a pool of computing resources.

During the step of servicing the workload, actual resource consumption is monitored by a measuring application which may be external to the server. Non-limiting examples of such a measuring application include application-level load monitors such as Hewlett Packard OpenView (Hewlett Packard Co., Palo Alto, Calif.), Tivoli (International Business Machines Corp., Armonk, N.Y.), and PowerRecon (PlateSpin Ltd., Toronto, Canada). The measuring application is configured also to update the historical resource consumption profile (update_load_history_event) for the task for the next corresponding time period (in the FIG. 5 example, Monday to Monday, Tuesday to Tuesday, etc.). As described above in the discussion of FIG. 4, certain of the allocated computing resources are marked as preemptible, such that other applications may divert the resources if not in use by the original owning application.

Certain advantages of the invention over the prior art should now be readily apparent. For example, by use of the marking/preemption feature of the present invention, computing resources may be shared not only between tiers of the same computing application, but also between applications, reducing the data-center footprint. As is known in the art, computing resources marked as non-preemptible may be diverted by higher priority applications, guaranteeing availability of mission-critical applications without increasing costs, by diverting resources from low-priority applications. Concurrently, computing resources marked as preemptible can be diverted even to lower-priority applications which would otherwise encounter resource starvation, improving efficiency of non-mission-critical applications by making otherwise idle resources available. Even more, the updating function of the present invention, that is, the updating of the predicted computing resource consumption profile using actual resource consumption monitoring, allows continuous optimization and fine-tuning of computing resource consumption predictions for a following time slot in the cycle, further enhancing the efficiency of the process. Thus, expensive and error-prone one-shot manual pre-allocation processes are replaced with a reliable, automated solution for pre-allocating computing resources for recurring computing tasks.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing system environment, a method for allocating computing resources, comprising:
before an application requires use of a pool of computing resources to service a workload, allocating at least a portion of the computing resources to the application according to a resource usage profile for the workload;
determining an amount of the computing resources used by the application in servicing the workload; and
updating the resource usage profile for the workload according to the determined amount of the computing resources used by the application to service the workload.

2. The method of claim 1, wherein the workload has a pattern which is cyclical over a predetermined time period.

3. The method of claim 1, including the further step of making allocated computing resources not required for servicing the workload available for use by one or more applications in need thereof.

4. The method of claim 3, wherein the computing resources not required for servicing the workload are released.

5. The method of claim 3, wherein at least a portion of the computing resources are marked as releasable in response to a request from one or more applications in need thereof.

6. In a computing system environment, a method for continuous optimization of allocation of computing resources, comprising:
providing a plurality of servers hosting a pool of computing resources defined by virtual machines and a database comprising a predicted computing resource consumption profile for an application configured for servicing a workload during one or more time slots;
providing a computing resource allocation application;
providing a measuring application which measures actual consumption of computing resources required to service the workload;
prior to initiation of a time slot, causing the computing resource allocation application to pre-allocate computing resources to the application according to the predicted computing resource consumption profile for the workload during the time slot;
measuring actual consumption of computing resources during the servicing of the workload; and
updating the predicted computing resource consumption profile database according to the measured actual consumption of computing resources required by the application.

7. The method of claim 6, wherein the workload has a pattern which is cyclical over a predetermined time period.

8. The method of claim 6, wherein the computing resource allocation application allocates computing resources in response to a request from the application for servicing the workload.

9. The method of claim 6, including the further step of causing the computing resource allocation application to make pre-allocated computing resources not required for servicing the workload available for use by one or more applications in need thereof.

10. The method of claim 9, wherein the computing resource allocation application releases any pre-allocated computing resources not required to service the workload.

11. The method of claim 9, wherein the computing resource allocation application marks at least a portion of the pre-allocated computing resources as releasable in response to a request from one or more applications in need thereof.

12. A computing system for continuously optimizing the allocation of computing resources, comprising:
a plurality of servers hosting a pool of computing resources defined by virtual machines and a database comprising a predicted computing resource consumption profile for an application configured for servicing a workload during one or more time slots;
a computing resource allocation application; and
a measuring application which measures actual consumption of computing resources required service the workload;
wherein the measuring application updates the predicted computing resource consumption profile database according to the measured actual consumption of computing resources by the application.

13. The system of claim 12, wherein the workload has a pattern which is cyclical over a predetermined time period.

14. The system of claim 13, wherein the computing resource allocation application, prior to initiation of a time slot, pre-allocates computing resources to the application according to the predicted computing resource consumption profile for the workload during the time slot.

15. The system of claim 13, wherein the computing resource allocation application is configured to make pre-allocated computing resources not required for servicing the workload available for use by one or more applications in need thereof.

16. The system of claim 15, wherein the computing resource allocation application releases any pre-allocated computing resources not required for servicing the workload.

17. The system of claim 15, wherein the computing resource allocation application is configured to mark at least a portion of the pre-allocated computing resources as releasable in response to a request from one or more applications in need thereof.

18. A computer program product available as a download or on a computer-readable medium for installation with a computing device of a user, said computer program product comprising:
a database component for storing a predicted computing resource consumption profile for a computing application configured for servicing a workload at one or more time slots;
a computing resource allocation component which is configured to allocate computing resources, defined by virtual machines, from a pool of computing resources; and
a measuring application component which is configured to measure actual consumption of computing resources during servicing of the workload;
further wherein the measuring application component is configured to update the predicted computing resource consumption profile database component according to the measured actual consumption of computing resources by the application in servicing the workload.

19. The computer program product of claim 18, wherein the computing resource allocation component is configured to make pre-allocated computing resources not required for servicing the workload available for use by other applications.

20. The computer program product of claim 19, wherein the computing resource allocation component is configured to release pre-allocated computing resources not required for completion of the recurring computing task available for use by one or more applications in need thereof.

21. The computer program product of claim 19, wherein the computing resource allocation component is configured to mark at least a portion of the pre-allocated computing resources as releasable in response to a request from one or more applications in need thereof.

22. A method for continuous optimization of allocation of computing resources, comprising:
providing a database comprising a predicted computing resource consumption profile for an application for servicing a workload at one or more time intervals;
pre-allocating computing resources defined by virtual machines, according to the predicted computing resource consumption profile;
measuring actual consumption of computing resources required to service the workload; and
updating the predicted computing resource consumption profile database according to the measured actual consumption of computing resources by the application.

23. The method of claim 22, wherein the workload has a pattern which is cyclical over a predetermined time period.

24. The method of claim 22, including the further step of making pre-allocated computing resources not required for servicing the workload available for use by one or more applications in need thereof.

25. The method of claim 24, wherein the pre-allocated computing resources not required to complete the recurring computing task are released.

26. The method of claim 24, wherein at least a portion of the pre-allocated computing resources not required to complete the recurring computing task are marked as releasable in response to a request from one or more applications in need thereof.

27. The method of claim 22, including the further step of providing a computing resource allocation application for pre-allocating computing resources and for making pre-allocated computing resources not required for servicing the workload available for use by one or more applications in need thereof.

28. The method of claim 22, including the further step of providing a measuring application for measuring actual consumption of computing resources required by the application to service the workload and for updating the predicted computing resource consumption profile database.
